(19) United States
(12) Patent Application Publication
(10) Pub. No.: US 2014/0343904 A1
(43) Pub. Date: Nov. 20, 2014

(54) METHOD FOR DESIGNING LENS

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 13/961,689

(22) Filed: Aug. 7, 2013

(30) Foreign Application Priority Data
May 16, 2013 (TW) 102117316

(51) Int. Cl. G06F 17/50

(52) U.S. Cl. CPC G06F 17/5009
USPC 703/2

(57) ABSTRACT

A method for designing a lens is disclosed. A curve of a light incident face of the lens is defined by a formula of Y₁=a₅X₁⁵+a₄X₁⁴+a₃X₁³+a₂X₁²+a₁X₁¹+a₀X₁⁰. A curve of a light emerging face of the lens is defined by a formula of Y₂b₅X₂⁵+b₄X₂⁴+b₃X₂³+b₂X₂²+b₁X₂¹+b₀X₂⁰. X₁ is an X-axis coordinate of the curve of the light incident face, and Y₁ is a Y-axis coordinate of the curve of the light incident face. X₂ is an X-axis coordinate of the curve of the light emerging face, and Y₂ is a Y-axis coordinate of the curve of the light emerging face. For the two formulas, a₅≠b₅, a₄≠b₄, a₃≠b₃, a₂≠b₂, a₁≠b₁, a₀≠b₀.

### BACKGROUND

1. Technical Field

The disclosure generally relates to a method, and more particularly, to a method for designing a lens.

2. Description of Related Art

Lens is an important optical element for adjusting light. A lens generally has a complicated optical face to achieve a desired light distribution. However, the complicated optical face of the lens is difficult to design, thereby resulting in high cost of the lens.

What is needed, therefore, is a method for designing a lens which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 shows a lens designed by a method in accordance with an embodiment of the present disclosure.

FIG. 2 shows two curves of a light incident face and a light emerging face of the lens of FIG. 1.

### DETAILED DESCRIPTION

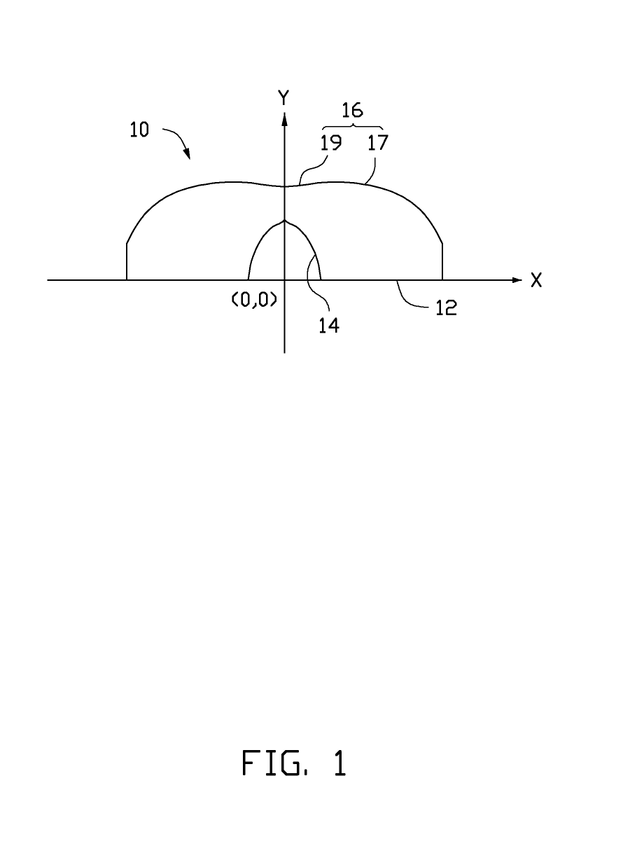

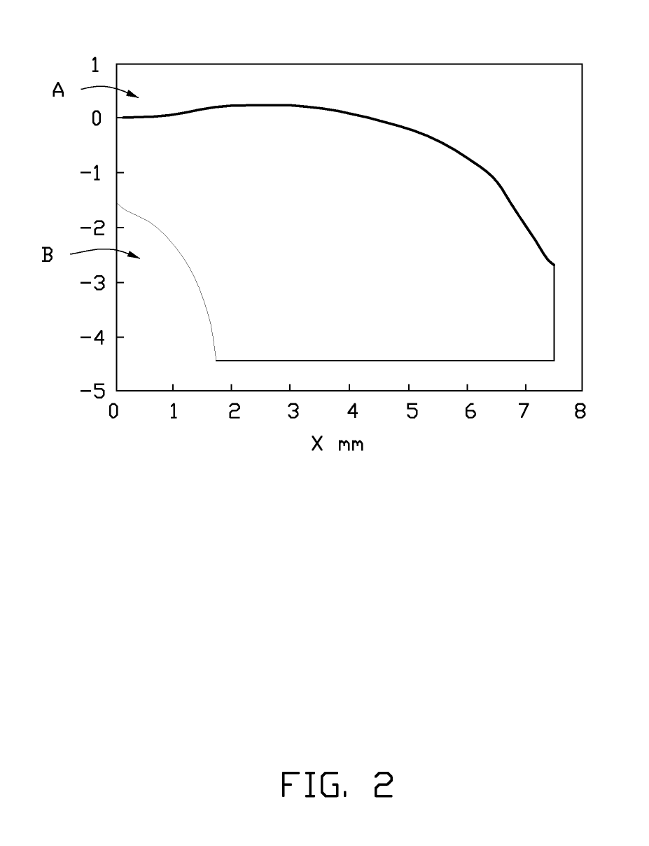

Referring to FIGS. 1-2, a method for designing a lens 10 in accordance with an embodiment of the present disclosure is shown. The method mainly includes following steps:

Firstly, a coordinate system is set for the lens 10. The coordinate system includes an X axis and a Y axis perpendicular to the X axis. The X axis intersects with the Y axis at a coordinate (0, 0). A center of a bottom face 12 of the lens 10 is located on the coordinate (0, 0). The lens 10 includes a light incident face 14 and a light emerging face 16 opposite to the light incident face 14. The light incident face 14 is a concave face, and the light emerging face 16 is a freeform face including two convex faces 17 and a concave face 19 interconnecting the two convex faces 17. A center of the light incident face 14 of the lens 10 is located on the Y axis. A center of the light emerging face 16 of the lens 10 is also located on the Y axis. The center of the light emerging face 16 is higher than the center of the light incident face 14.

The light incident face 14 is defined by a formula of Y=a₅X⁵+a₄X⁴+a₃X³+a₂X²+a₁X¹+a₀X⁰, and the light emerging face 16 is defined by a formula of Y=b₅X⁵+b₄X⁴+b₃X³+b₂X²+b₁X¹+b₀X⁰. Thus, different coordinates of the light incident face 14 and the light emerging face 16 can be calculated according to the formulas. In detail, an arithmetic progression (X₁, 2X₁, 3X₁, . . . nX₁) is set for X-axis coordinates of the light incident face 14, and an arithmetic progression (X₂, 2X₂, 3X₂, . . . nX₂) is set for X-axis coordinates of the light emerging face 16. A value of nX₁ is equal to a radius of the light incident face 14, and a value of nX₂ is equal to a radius of the light emerging face 16. Y-axis coordinates of the light incident face 14 are calculated by substituting the arithmetic progression (X₁, 2X₁, 3X₁, . . . nX₁) into the formula of Y=a₅X⁵+a₄X⁴+a₃X³+a₂X²+a₁X¹+a₀X⁰. For example, assuming the radius of the light incident face 14 is 15 mm, the arithmetic progression of the X-axis coordinates is selected as (3, 6, 9, 12, 15). The Y-axis coordinates of the light incident face 14 is thus calculated as a₅3⁵+a₄3⁴+a₃3³+a₂3²+a₁3¹+a₀3⁰, a₅6⁵+a₄6⁴+a₃6³+a₂6²+a₁6¹+a₀6⁰, a₅9⁵+a₄9⁴+a₃9³+a₂9²+a₁9¹+a₀9⁰, a₅12⁵+a₄12⁴+a₃12³+a₂12²+a₁12¹+a₀12⁰ and a₅15⁵+a₄15⁴+a₃15³+a₂15²+a₁15¹+a₀15⁰, respectively. Thus, each coordinate of the light incident face 14 is determined by corresponding the X-axis coordinates to the Y-axis coordinates. In this embodiment, the coordinates of the light incident face 14 are (3, s₅3⁵+a₄3⁴+a₃3³+a₂3²+a₁3¹+a₀3⁰), (6, a₅6⁵+a₄6⁴+a₃6³+a₂6²+a₁6¹+a₀6⁰), (9, a₅9⁵+a₄9⁴+a₃9³+a₂9²+a₁9¹+a₀9⁰), (12, a₅12⁵+a₄12⁴+a₃12³+a₂12²+a₁12¹+a₀12⁰) and (15, a₅15⁵+a₄15⁴+a₃15³+a₂15²+a₁15¹+a₀15⁰. Each coordinate is then depicted in the coordinate system by a point. The points of the coordinates of the light incident face 14 are further connected by smooth lines to obtain a curve of the light incident face 14. Similar to the light incident face 14, Y-axis coordinates of the light emerging face 16 are also calculated by substituting the arithmetic progression (X₂, 2X₂, 3X₂, . . . .nX₂) into the formula of Y=b₅X⁵+b₄X⁴+b₃X³+b₂X²+b₁X¹+b₀X⁰. Thus, each coordinate of the light emerging face 16 is determined. Points of the coordinates of the light emerging face 16 are further connected by smooth lines to obtain a curve of the light emerging face 16. Thus, design of the lens 10 is completed.

Preferably, for the light incident face 14, a₅=0.000954886275244729, a₄=0.0148913229095743, a₃=−0.0890847442543703, a₂=0.186933025172157, a₁=−0.00907732217820396, a₀=−0.00894782117990517; for the light emerging face 16, b₅=−1.24619103245084, b₄=5.03769795257253, b₃=−7.92370477400477, b₂=5.27001084268116, b₁=−2.02290743519007, b₀=−1.45775675991550.

The lens 10 can be easily and conveniently designed according to the method as disclosed above. Thus, cost of the lens 10 is reduced accordingly. Particularly, the lens 10 designed by the method can diverge light widely in a large angle. A light intensity at an optical axis of the lens 10 is 11.99% of a light intensity at an angle deviated 75 degrees from the optical axis of the lens 10.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for designing a lens, comprising:
setting a coordinate system comprising an X axis and a Y axis intersecting the X axis;
defining a curve of a light incident face of the lens by a formula of Y₁=a₅X₁⁵+a₄X₁⁴+a₃X₁³+a₂X₁²+a₁X₁¹+a₀X₁⁰, wherein X₁ is an X-axis coordinate of the curve of the light incident face, Y₁ is a Y-axis coordinate of the curve of the light incident face, and a₅, a₄, a₃, a₂, a₁ and a₀ are constant; and
defining a curve of a light emerging face of the lens by a formula of Y₂=b₅X₂⁵+b₄X₂⁴+b₃X₂³+b₂X₂²+b₁X₂¹+b₀X₂⁰, wherein X₂ is an X-axis coordinate of the curve of the light emerging face, Y₂ is a Y-axis coordinate of the curve of the light emerging face, and b₅, b₄, b₃, b₂, b₁ and a₀ are constant.

2. The method of claim 1, wherein the curve of the light incident face is defined by steps:
selecting an arithmetic progression (X₁, 2X₁, 3X₁, . . . nX₁) as multiple X-axis coordinates of the light incident face;
substituting the arithmetic progression (X₁, 2X₁, 3X₁, . . . nX₁) into the formula of Y₁=a₅X₁⁵+a₄X₁⁴+a₃X₁³+a₂X₁²+a₁X₁¹+a₀X₁⁰, thereby obtaining multiple Y-axis coordinates of the light incident face;
depicting points of the coordinates of the light incident face according to the X-axis coordinates and the Y-axis coordinates; and
connecting the points by smooth lines to form the curve of the light incident face.

3. The method of claim 1, wherein the curve of the light emerging face is defined by steps:
selecting an arithmetic progression (X₂, 2X₂, 3X₂, . . . nX₂) as multiple X-axis coordinates of the light emerging face;
substituting the arithmetic progression (X₂, 2X₂, 3X₂, . . . nX₂) into the formula of Y₂=b₅X₂⁵+b₄X₂⁴+b₃X₂³+b₂X₂²+b₁X₂¹+b₀X₂⁰, thereby obtaining multiple Y-axis coordinates of the light emerging face;
depicting points of the coordinates of the light emerging face according to the X-axis coordinates and the Y-axis coordinates; and
connecting the points by smooth lines to form the curve of the light emerging face.

4. The method of claim 1, wherein a₅≠b₅, a₄≠b₄, a₃≠b₃, a₂≠b₂, a₁≠b₁, a₀≠b₀.

5. The method of claim 4, wherein a₅=0.000954886275244729, a₄=0.0148913229095743, a₃=−0.0890847442543703, a₂=0.186933025172157, a₁=−0.00907732217820396, a₀=−0.00894782117990517.

6. The method of claim 4, wherein b₅=−1.24619103245084, b₄=5.03769795257253, b₃=−7.92370477400477, b₂=5.27001084268116, b₁=−2.02290743519007, b₀=−1.45775675991550.

7. The method of claim 1, wherein the light incident face is a concave face.

8. The method of claim 1, wherein the light emerging face comprises two convex faces and a concave face interconnecting the two convex faces.

9. The method of claim 1, wherein the light incident face has a center located on the Y axis, and the light emerging face also has a center located on the Y axis.

10. The method of claim 9, wherein the center of the light emerging face is located higher than the center of the light incident face.
